(19) United States
(12) Patent Application Publication
(10) Pub. No.: US 2024/0405480 A1
(43) Pub. Date: Dec. 5, 2024

(54) CONNECTOR AND CONNECTOR ASSEMBLY

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Thomas CRUBLE, Mie (JP)

(21) Appl. No.: 18/694,913

(22) PCT Filed: Sep. 14, 2022
(86) PCT No.: PCT/JP2022/034437

§ 371 Date: Mar. 22, 2024

(30) Foreign Application Priority Data
Sep. 30, 2021 (JP) 2021-161412

(51) Int. Cl. H01R 13/629

(52) U.S. Cl. CPC H01R 13/62938; H01R 13/62955

(57) ABSTRACT

A connector includes a connector housing, a lever that is movable relative to the connector housing along a first axis, an arm that is drivingly coupled to the lever, and a lock member that is movable relative to the lever. The connector housing is configured to approach a state of fit to the counterpart housing as the lever moves from the first position to the second position. The lock member regulates a movement of the lever located at the second position by regulating a movement of the arm such that the lock member is not allowed to make contact with the arm in a state in which the lock member is located at the third position, and is allowed to make contact with the arm in a state in which the lock member is located at the fourth position.

### TECHNICAL FIELD

The present disclosure relates to a connector and a connector assembly.

### BACKGROUND

Conventionally, vehicles such as a hybrid car and an electric car are provided with onboard equipment including a high pressure battery and an inverter. Onboard equipment is connected to another via a wire harness and a connector assembly. A connector assembly includes a counterpart connector and a connector that can be connected to the counterpart connector by a relative movement in a first direction along a first axis. The counterpart connector includes a counterpart terminal and a counterpart housing. The connector includes a terminal electrically connectable to the counterpart terminal and a connector housing that can be fit to the counterpart housing. Such a connector thus includes a lock member for keeping a fit state in which a connector housing is fit onto a counterpart housing (for example, see Patent Document 1). Specifically, the counterpart housing has a protrusion extending in a direction crossing the first axis, and the connector housing has an engaging portion that is so flexible as to engage with the protrusion. When the lock member is slid to a locking position relative to the connector housing in a fit state in which the connector housing is fit onto the counterpart housing, the lock member keeps the engagement between the protrusion and the engaging portion by suppressing deformation of the engaging portion. The connector configured thus can suppress easy disengagement caused by, for example, external forces such as vibrations.

### PRIOR ART DOCUMENT

### Patent Document

Patent Document 1: JP 2020-145191 A

### SUMMARY OF THE INVENTION

### Problems to be Solved

However, the connector assembly is configured to keep a fit state by engaging the engaging portion with a small protrusion that extends in a direction crossing the first axis. Thus, even if deformation of the engaging portion is suppressed at the lock member, disengagement is likely to occur.

The present disclosure has been devised to solve the problem. An object of the present disclosure is to provide a connector and a connector assembly that are capable of firmly keeping a fit state.

### Means to Solve the Problem

A connector according to the present disclosure is a connector connectable to a counterpart connector by a relative movement in a first direction along a first axis, the counterpart connector including a counterpart terminal and a counterpart housing, the connector including: a terminal connectable to the counterpart terminal; a connector housing that accommodates the terminal and is allowed to be fit onto the counterpart housing; a lever that is mounted on the connector housing and is movable relative to the connector housing along the first axis in a range from a first position to a second position ahead of the first position in the first direction; an arm that is mounted on the connector housing, is drivingly coupled to the lever, and moves in a direction different from the moving direction of the lever according to a relative movement of the lever, and a lock member that is mounted on the lever and is movable relative to the lever in a range from a third position to a fourth position, wherein the connector housing is configured to approach a state of fit to the counterpart housing as the lever moves from the first position to the second position, the lock member regulates a movement of the lever located at the second position by regulating a movement of the arm such that the lock member is not allowed to make contact with the arm in a state in which the lock member is located at the third position, and is allowed to make contact with the arm in a state in which the lock member is located at the fourth position.

A connector assembly according to the present disclosure includes the connector and the counterpart connector.

### Effect of the Invention

According to the connector and the connector assembly of the present disclosure, a fit state can be firmly kept.

### BRIEF DESCRIPTION OF THE DRAWINGS

FIG. 1 is an exploded perspective view illustrating a connector assembly according to an embodiment.

FIG. 2 is an exploded perspective view illustrating a connector according to the embodiment.

FIG. 3 is a plan view illustrating a connector housing and an arm according to the embodiment.

FIG. 4 is a partial perspective view illustrating a lever and a lock member according to the embodiment.

FIG. 5 is a plan view illustrating the connector assembly according to the embodiment.

FIG. 6 is a plan view illustrating the connector assembly according to the embodiment.

FIG. 7 is an explanatory drawing of the positional relationship between the arm and the lock member according to the embodiment.

FIG. 8 is an explanatory drawing of the positional relationship between the arm and the lock member according to the embodiment.

### DETAILED DESCRIPTION TO EXECUTE THE INVENTION

### Description of Embodiment of Present Disclosure

An embodiment of the present disclosure will be first described in list form.

[1] A connector according to the present disclosure is a connector connectable to a counterpart connector by a relative movement in a first direction along a first axis, the counterpart connector including a counterpart terminal and a counterpart housing, the connector including: a terminal connectable to the counterpart terminal; a connector housing that accommodates the terminal and is allowed to be fit onto the counterpart housing; a lever that is mounted on the connector housing and is movable relative to the connector housing along the first axis in a range from a first position to a second position ahead of the first position in the first direction; an arm that is mounted on the connector housing, is drivingly coupled to the lever, and moves in a direction different from the moving direction of the lever according to a relative movement of the lever, and a lock member that is mounted on the lever and is movable relative to the lever in a range from a third position to a fourth position, wherein the connector housing is configured to approach a state of fit to the counterpart housing as the lever moves from the first position to the second position, the lock member regulates a movement of the lever located at the second position by regulating a movement of the arm such that the lock member is not allowed to make contact with the arm in a state in which the lock member is located at the third position, and is allowed to make contact with the arm in a state in which the lock member is located at the fourth position.

With this configuration, when the lever is moved from the first position to the second position, the connector housing is fit into the counterpart housing. Thereafter, when the lock member is located at the fourth position, the lock member regulates a movement of the arm so as to regulate a movement of the lever located at the second position, thereby keeping the fit state. The lock member regulates a movement of the arm by making contact with the arm that moves in a different direction from the moving direction of the lever according to a movement of the lever. Thus, for example, as compared with a simple configuration that keeps a state of fit to a protrusion that extends in a direction crossing the first axis, a fit state can be more firmly kept. In other words, the lock member is configured to keep a fit state by regulating a movement of the arm while making contact with the arm that moves in a different direction from the first axis, along which the counterpart housing and the connector housing are fit to each other, thereby firmly keeping a fit state.

[2] It is preferable that the arm has an engaging portion that is allowed to be engaged with an engaged portion of the counterpart housing, and the connector housing is configured to move relative to the counterpart housing and approach a state of fit to the counterpart housing as the engaging portion in engagement with the engaged portion moves according to a movement of the lever from the first position to the second position.

With this configuration, the arm moves as the lever moves from the first position to the second position, and the engaging portion in engagement with the engaged portion of the counterpart housing also moves, so that the connector housing can be brought close to a state of fit to the counterpart housing.

[3] It is preferable that a movement of the lock member from the third position to the fourth position is regulated in a state in which the lever is located at the first position.

With this configuration, a wrong operation, for example, moving the lock member from the third position to the fourth position with the lever located at the first position can be prevented. This can avoid interference with a movement of the lever in the event of, for example, a wrong operation of the lock member, thereby avoiding problems, for example, interference with a fit of the connector housing onto the counterpart housing.

[4] It is preferable that the arm includes a shaft portion that is allowed to make contact with the lock member, the shaft portion moves from a fifth position to a sixth position as the lever moves from the first position to the second position, the lock member does not overlap the moving path of the shaft portion from the fifth position to the sixth position in a state in which the lock member is located at the third position, and the lock member overlaps the moving path of the shaft portion from the fifth position to the sixth position in a state in which the lock member is located at the fourth position.

With this configuration, the lock member does not overlap the moving path of the shaft portion from the fifth position to the sixth position in a state in which the lock member is located at the third position. Thus, a movement of the arm is unregulated, and a movement of the lever is also unregulated. Moreover, the lock member overlaps the moving path of the shaft portion from the fifth position to the sixth position in a state in which the lock member is located at the fourth position, so that a movement of the arm is regulated. Thus, a movement of the lever located at the second position to the first position is regulated, thereby keeping a fit state.

[5] It is preferable that the shaft portion constitutes a coupling portion that is drivingly coupled to the lever so as to move the arm in a direction different from the moving direction of the lever according to a relative movement of the lever.

With this configuration, the shape of the arm is simplified as compared with the case where a configuration separate from the shaft portion serves as a coupling portion that is drivingly coupled to the lever so as to move the arm in a direction different from the moving direction of the lever according to a relative movement of the lever. In other words, the shaft portion that can make contact with the lock member also constitutes the coupling portion drivingly coupled to the lever. Thus, the shape of the arm is simplified as compared with that in separate configurations.

[6] It is preferable that the lock member has a lock-side first flat surface along an axis along which the lock member is movable with respect to the lever and the shaft portion has a shaft-side first flat surface that is allowed to make surface contact with the lock-side first flat surface.

With this configuration, the lock member and the shaft portion have the lock-side first flat surface and the shaft-side first flat surface that can make surface contact with each other. Thus, the contact portion is unlikely to be broken as compared with, for example, that of a configuration having point contact or line contact. Hence, the lock member and the shaft portion can be brought into contact with each other at a stable position.

[7] It is preferable that the lock member has a lock-side second flat surface along an axis orthogonal to an axis along which the lock member is movable with respect to the lever and the shaft portion has a shaft-side second flat surface that is allowed to make surface contact with the lock-side second flat surface.

With this configuration, the lock member and the shaft portion have the lock-side second flat surface and the shaft-side second flat surface that can make surface contact with each other. Thus, the contact portion is unlikely to be broken as compared with, for example, that of a configuration having point contact or line contact. Hence, the lock member and the shaft portion can be brought into contact with each other at a stable position.

[8] A connector assembly according to the present disclosure includes the connector and the counterpart connector.

With this configuration, a fit state can be firmly kept in the connector assembly.

### Detailed Description of Embodiment of Present Disclosure

A specific example of a connector assembly according to the present disclosure will be described below with reference to the accompanying drawings. In the drawings, some configurations may be exaggerated or simplified for convenience of explanation. Moreover, the scale ratios of parts may vary among the drawings. “Parallel,” “orthogonal,” and “perfect circle” in the present specification mean nearly parallel, nearly orthogonal, and a nearly perfect circle within the scope of the working-effect of the present embodiment as well as strictly parallel, strictly orthogonal, and a strictly perfect circle. The present invention is not limited to these illustrations and is intended to include meanings equivalent to the claims and all changes in the scope.

### Configuration of Connector Assembly 11

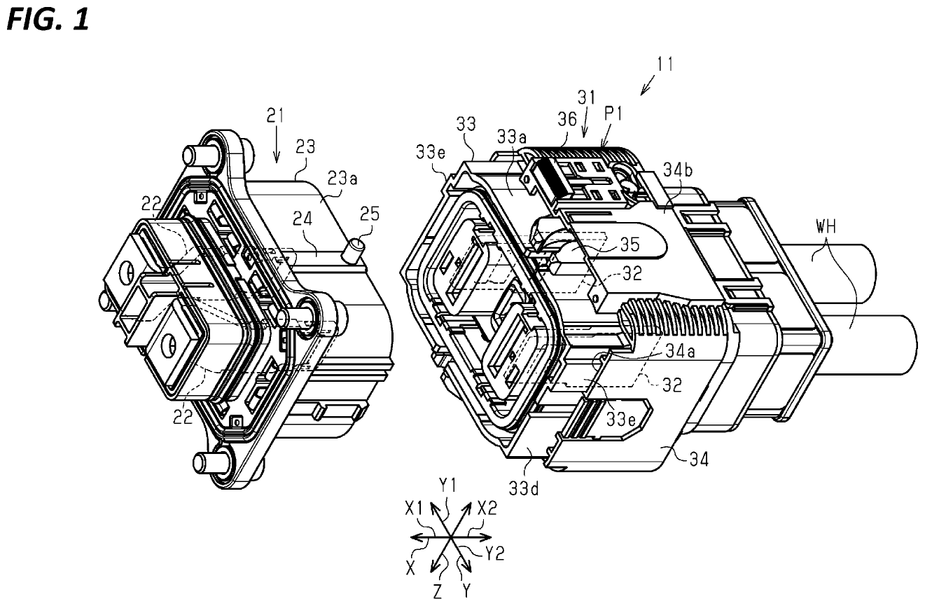

As illustrated in FIG. 1, a connector assembly 11 includes a counterpart connector 21 and a connector 31 that can be connected to the counterpart connector 21 by a relative movement in a first direction X1 along a first axis X. The connector assembly 11 is provided in a vehicle. For example, a vehicle includes onboard equipment including a high pressure battery and an inverter, which are connected to each other via wire harnesses WH. The connector assembly 11 is provided as, for example, a component for connecting the onboard equipment and the wire harnesses WH. FIG. 1 illustrates the first axis X, a second axis Y orthogonal to the first axis X, and a third axis Z orthogonal to the first axis X and the second axis Y.

### Configuration of Counterpart Connector 21

The counterpart connector 21 includes counterpart terminals 22 and a counterpart housing 23 that accommodates the counterpart terminals 22. The counterpart terminals 22 extend along the first axis X. The two counterpart terminals 22 are provided in parallel along the second axis Y. The counterpart terminal 22 has one end connected to, for example, the connecting terminal of onboard equipment in the first direction X1. The counterpart housing 23 is configured with an insulating resin material. The counterpart housing 23 is shaped like a square pillar opened in the first opposite direction X2 opposite to the first direction X1. A wall portion 23a extending along the second axis Y on the counterpart housing 23 has a protruding extension 24 that protrudes outward along the third axis Z and extends along the first axis X. Furthermore, an engaged portion 25 protruding along the third axis Z is provided on the side of the first opposite direction X2 of the protruding extension 24. The engaged portion 25 is shaped like a circular cylinder. On the counterpart housing 23, one end on the side of the first direction X1 is fixed to, for example, the housing of onboard equipment.

### Configuration of Connector 31

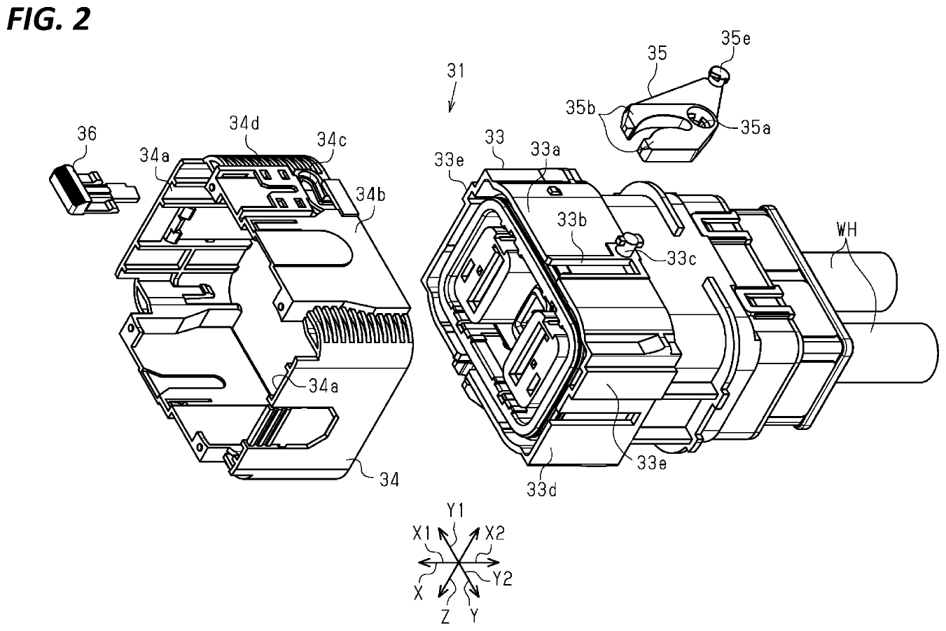

As illustrated in FIGS. 1 and 2, the connector 31 includes terminals 32, a connector housing 33 accommodating the terminals 32, and a lever 34 and an arm 35 that are attached to the connector housing 33, and a lock member 36 mounted on the lever 34.

### Configuration of Terminal 32

As illustrated in FIG. 1, the terminals 32 extend along the first axis X. The two terminals 32 are provided in parallel along the second axis Y and are disposed to be electrically connectable to the respective counterpart terminals 22. On the terminal 32, one end on the side of the first opposite direction X2 is connected to the core wire of the wire harness WH.

### Configuration of Connector Housing 33

The connector housing 33 is configured with an insulating resin material.

As illustrated in FIGS. 1 and 2, the connector housing 33 is shaped like a square pillar opened in the first direction Xl. The connector housing 33 is configured to be fit onto the counterpart housing 23. Specifically, the connector housing 33 can be fit onto the counterpart housing 23 by moving the connector 31 in the first direction X1 relative to the counterpart connector 21. As illustrated in FIG. 2, on the connector housing 33, a wall portion 33a extending along the second axis Y has a slit 33b that penetrates along the third axis Z and extends along the first axis X. The slit 33b extends in the first opposite direction X2 from one end of the connector housing 33 on the side of the first direction X1. The slit 33b is formed so as to accommodate the protruding extension 24 of the counterpart housing 23. The wall portion 33a also has a rotating shaft 33c that projects outward along the third axis Z. The rotating shaft 33c is provided at the center of the connector housing 33 in the width direction along the second axis Y. Moreover, a wall portion 33d extending along the third axis Z on the connector housing 33 has a rail portion 33e that protrudes outward along the second axis Y and extends along the first axis X.

### Configuration of Lever 34

The lever 34 is configured with a resin material.

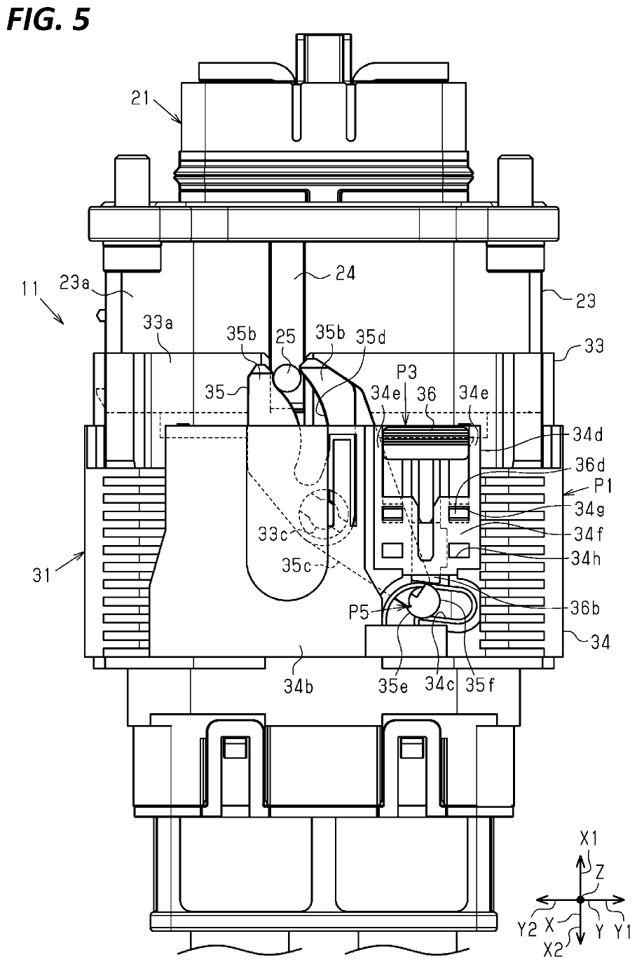

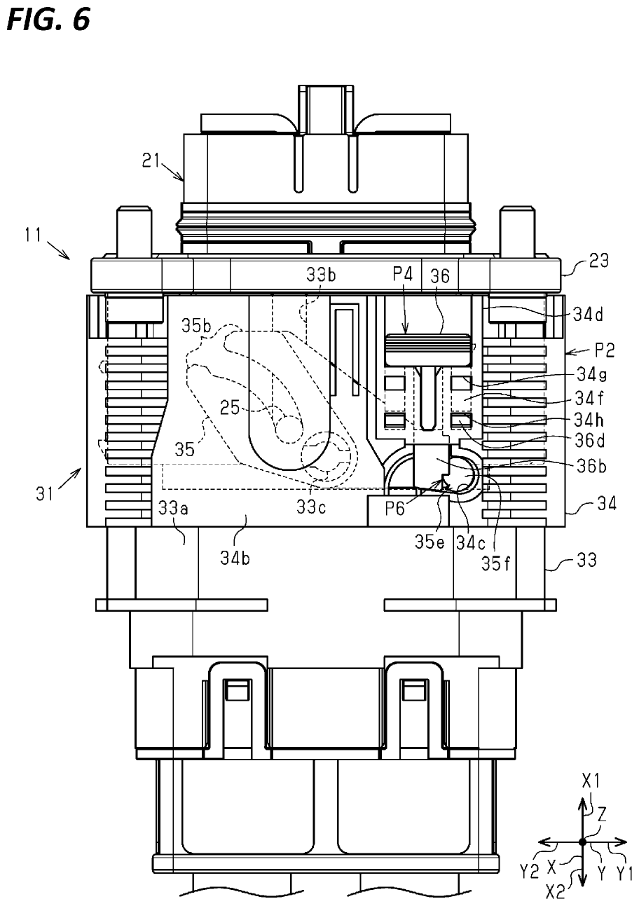

As illustrated in FIGS. 1 and 2, the lever 34 is shaped like a square pillar. The inner surface of the lever 34 has a concave portion 34a that extends along the first axis X and can be fit onto the rail portion 33e of the connector housing 33. The lever 34 is fit onto the connector housing 33. The lever 34 can be moved relative to the connector housing 33 along the first axis X by guiding the concave portion 34a to the rail portion 33e. The lever 34 can be moved relative to the connector housing 33 in the range from a first position P1 (see FIGS. 1 and 5) on the side of the first opposite direction X2 to a second position P2 (see FIG. 6) located ahead of the first position P1 in the first direction X1.

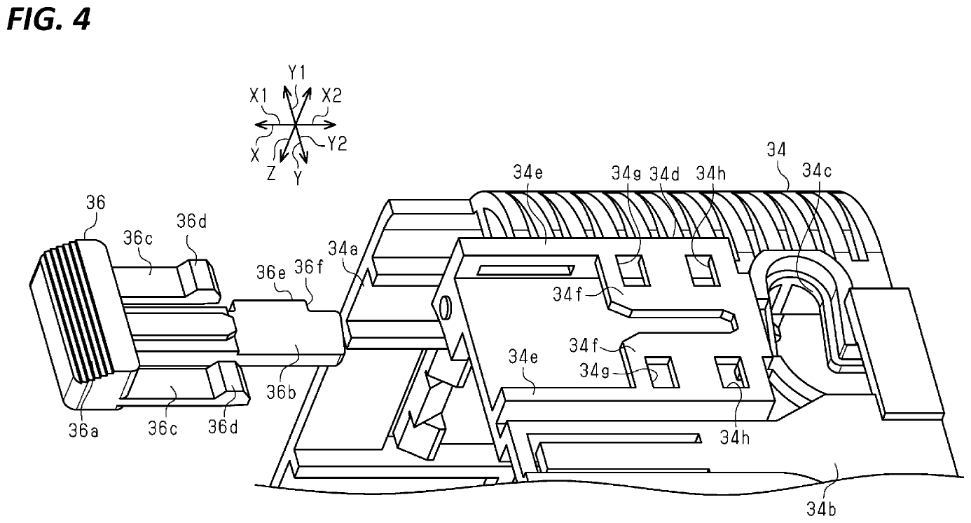

As illustrated in FIGS. 4 to 6, on the lever 34, a wall portion 34b extending along the second axis Y has a coupled portion 34c penetrating along the third axis Z. As illustrated in FIGS. 5 and 6, the coupled portion 34c is provided near one end on the lever 34 in the second direction Y1 along the second axis Y. The coupled portion 34c extends along the second axis Y and slightly tilts toward the first opposite direction X2 as extending toward the second direction Y1.

As illustrated in FIG. 4, the wall portion 34b also have a mounting portion 34d where the lock member 36 can be mounted. The mounting portion 34d includes a pair of parallel side wall portions 34e that protrude outward from the wall portion 34b along the third axis Z and extend along the first axis X, and a pair of lid portions 34f that extend close to each other from the top portions of the side wall portions 34e. The lid portion 34f has a first holding hole 34g that penetrates along the third axis Z and a second holding hole 34h that is located ahead of the first holding hole 34g in the first opposite direction X2.

### Configuration of Arm 35

The arm 35 is configured with a resin material.

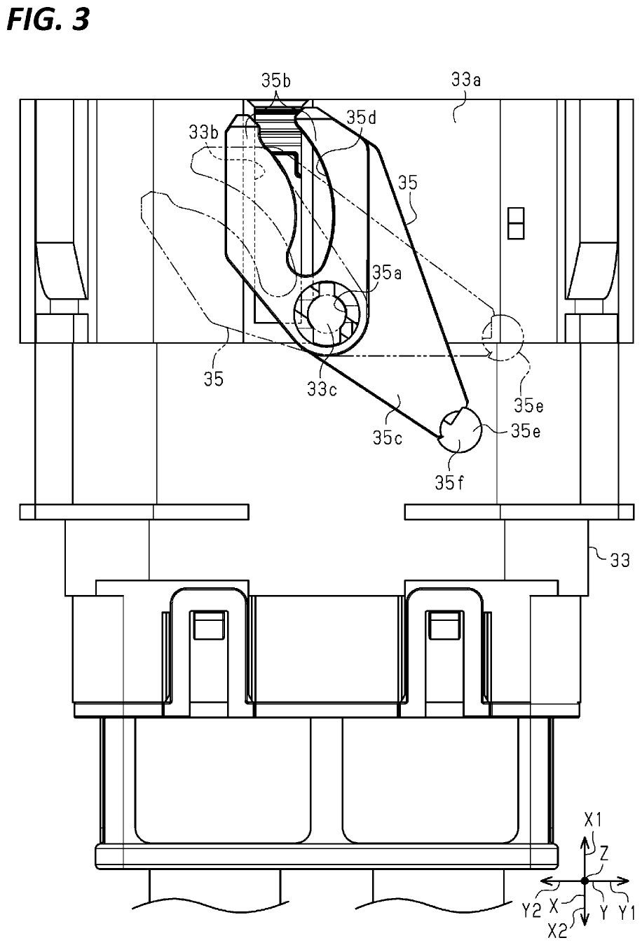

As illustrated in FIG. 3, the arm 35 has a central hole 35a, a pair of engaging portions 35b extending in one direction with respect to the central hole 35a, and an extended portion 35c that extends to the other direction opposite from the engaging portions 35b with respect to the central hole 35a. The arm 35 is attached to the connector housing 33 such that the rotating shaft 33c passes through the central hole 35a. In other words, the arm 35 is supported so as to pivot about the rotating shaft 33c. The arm 35 is provided such that the pair of engaging portions 35b pivots about the central hole 35a on the side of the second opposite direction Y2 that is opposite to the second direction Y1 and the extended portion 35c pivots about the central hole 35a on the side of the second direction Y1.

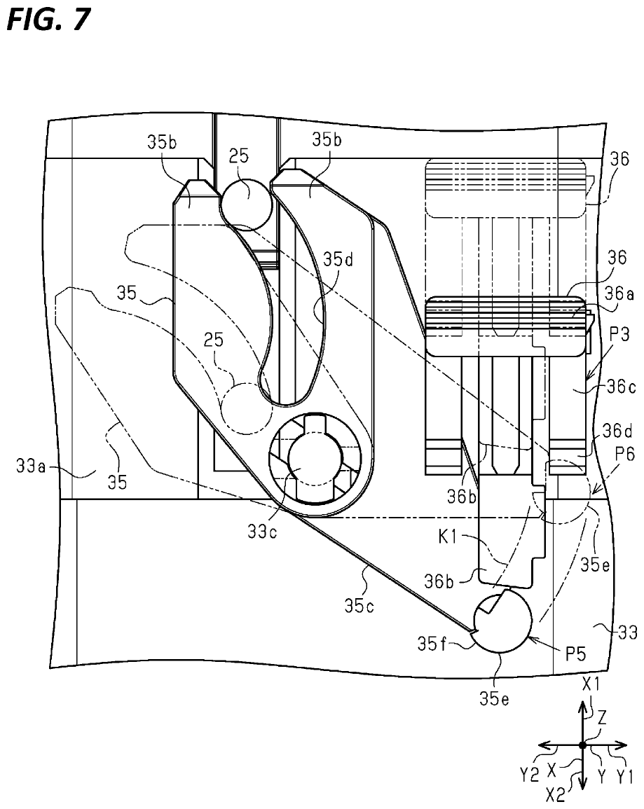

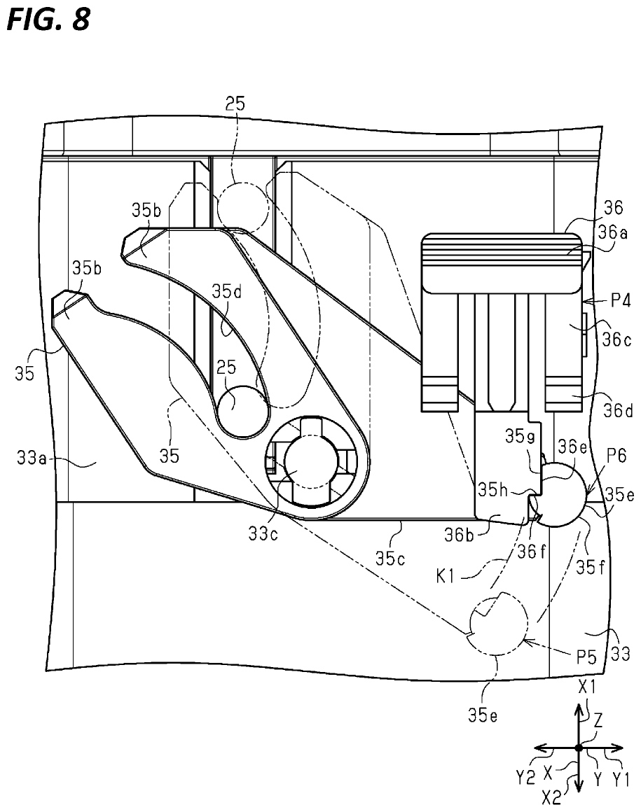

The pair of engaging portions 35b has opposing surfaces constituting a slit 35d. As illustrated in FIGS. 7 and 8, the clearance of the slit 35d is set such that the engaged portion 25 of the counterpart housing 23 can be inserted into the slit 35d. The slit 35d is curved in a direction that can draw the engaged portion 25 to the proximal side of the engaging portions 35b, that is, the side of the first opposite direction X2 by pivoting the arm 35 to move the distal-end side of the pair of engaging portions 35b in the first opposite direction X2.

The distal-end portion of the extended portion 35c has a shaft portion 35e that projects along the third axis Z. As illustrated in FIGS. 5 and 6, the shaft portion 35e is provided to penetrate the coupled portion 34c of the lever 34. The shaft portion 35e constitutes a coupling portion 35f that is drivingly coupled to the lever 34 so as to move the arm 35 in a direction different from the moving direction of the lever 34 according to a relative movement of the lever 34 along the first axis X. In other words, the shaft portion 35e constitutes the coupling portion 35f that is drivingly coupled to the lever 34 so as to pivot the arm 35 while moving in the coupled portion 34c according to a relative movement of the lever 34 along the first axis X.

With this configuration, the connector housing 33 is configured to approach a state of fit to the counterpart housing 23 as the lever 34 moves from the first position P1 (see FIG. 5) to the second position P2 (see FIG. 6). Specifically, the connector housing 33 is configured to move relative to the counterpart housing 23 and approach a state of fit to the counterpart housing 23 as the engaging portions 35b in engagement with the engaged portion 25 of the counterpart housing 23 move according to a movement of the lever 34 from the first position P1 to the second position P2. In other words, as the lever 34 moves from the first position P1 to the second position P2, the shaft portion 35e penetrating the coupled portion 34c of the lever 34 moves from a fifth position P5 (see FIG. 5) to a sixth position P6 and pivots the arm 35. Thus, the engaging portions 35b moving with the arm 35 operate to draw the engaged portion 25, so that the connector housing 33 moves relative to the counterpart housing 23 and approaches a state of fit to the counterpart housing 23.

### Configuration of Lock Member 36

The lock member 36 is configured with a resin material.

As illustrated in FIG. 4, the lock member 36 includes an operation portion 36a, a contact portion 36b, and a pair of position-keeping pieces 36c. The width of the operation portion 36a, that is, the length of the operation portion 36a along the second axis Y is set at a length that can be accommodated between the pair of side wall portions 34e in the mounting portion 34d of the lever 34. The contact portion 36b extends in the first opposite direction X2 from the center of the operation portion 36a in the width direction. The pair of position-keeping pieces 36c extends in the first opposite direction X2 from both ends of the operation portion 36a in the width direction. The contact portion 36b extends longer than the position-keeping pieces 36c. At the distal-end portion of the position-keeping piece 36c, a position-keeping protrusion 36d protruding in the direction of the third axis Z is provided.

The lock member 36 is assembled into the mounting portion 34d in the first opposite direction X2. As illustrated in FIGS. 5 and 6, the contact portion 36b penetrates the mounting portion 34d in the first opposite direction X2. The distal-end portions of the pair of position-keeping pieces 36c are accommodated in the mounting portion 34d. The lock member 36 can be moved relative to the lever 34 in the range from a third position P3 (see FIG. 5) where the position-keeping protrusion 36d is fit into the first holding hole 34g to a fourth position P4 (see FIG. 6) where the position-keeping protrusion 36d is fit into the second holding hole 34h. The position-keeping protrusion 36d can be disengaged by bending the position-keeping piece 36c from a state in which the position-keeping protrusion 36d is fit into the first holding hole 34g or the second holding hole 34h.

As illustrated in FIG. 5, the contact portion 36b of the lock member 36 does not come into contact with the shaft portion 35e of the arm 35 in a state in which the lock member 36 is located at the third position P3. Specifically, the contact portion 36b does not come into contact with the shaft portion 35e in a direction that interferes with a movement of the arm 35 in a state in which the lock member 36 is located at the third position P3. As illustrated in FIG. 7, the contact portion 36b is disposed ahead of the shaft portion 35e in the first direction X1 in a state in which the lock member 36 is located at the third position P3. Also when the shaft portion 35e moves in the first direction X1 (see chain double-dashed lines in FIG. 7), the lock member 36 moves with the lever 34 in the first direction X1, so that the contact portion 36b does not come into contact with the shaft portion 35e in a direction that interferes with a movement of the arm 35. In other words, the contact portion 36b does not overlap a moving path K1 of the shaft portion 35e from the fifth position P5 to the sixth position P6 in a state in which the lock member 36 is located at the third position P3.

Moreover, the contact portion 36b of the lock member 36 regulates a movement of the lever 34 located at the second position P2 to the first position P1, by regulating a movement of the arm 35 such that the contact portion 36b is allowed to make contact with the shaft portion 35e of the arm 35 in a state in which the lock member 36 is located at the fourth position P4. Specifically, as illustrated in FIG. 6, the contact portion 36b can make contact with the shaft portion 35e in a direction that interferes with a movement of the arm 35 in a state in which the lock member 36 is located at the fourth position P4. As illustrated in FIG. 8, the contact portion 36b is disposed ahead of the shaft portion 35e, which is located at the sixth position P6, in the second opposite direction Y2, in a state in which the lock member 36 is located at the fourth position P4. The contact portion 36b overlaps the moving path K1 of the shaft portion 35e from the fifth position P5 to the sixth position P6 in a state in which the lock member 36 is located at the fourth position P4.

Moreover, as illustrated in FIG. 5, in a state in which the lever 34 is located at the first position P1, that is, in a state in which the shaft portion 35e is located at the fifth position P5, a movement of the lock member 36 from the third position P3 to the fourth position P4 is regulated. In other words, the lock member 36 being moved toward the fourth position P4 from the third position P3 cannot be moved to the fourth position P4 because the contact portion 36b collides with the shaft portion 35e in a state in which the shaft portion 35e is located at the fifth position P5. Specifically, in the present embodiment, the lock member 36 is allowed to move from the third position P3 to the fourth position P4 only in a state in which the lever 34 is located at the second position P2, that is, in a state in which the shaft portion 35e is located at the sixth position P6.

As illustrated in FIG. 8, the contact portion 36b of the present embodiment has a lock-side first flat surface 36e along the first axis X, along which the lock member 36 is movable with respect to the lever 34. The shaft portion 35e has a shaft-side first flat surface 35g that can make surface contact with the lock-side first flat surface 36e.

Furthermore, the contact portion 36b of the present embodiment has a lock-side second flat surface 36f along the second axis Y that is an axis orthogonal to the first axis X, along which the lock member 36 is movable with respect to the lever 34. The shaft portion 35e has a shaft-side second flat surface 35h that can make surface contact with the lock-side second flat surface 36f. The lock-side first flat surface 36e and the lock-side second flat surface 36f are orthogonal to each other while being connected to each other. Moreover, the shaft-side first flat surface 35g and the shaft-side second flat surface 35h are orthogonal to each other while being connected to each other.

Operations performed when the connector assembly 11 configured thus is connected will be describe below.

As illustrated in FIG. 1, before the connector 31 is connected to the counterpart connector 21, the lever 34 is located at the first position P1. When the connector 31 is being connected to the counterpart connector 21, an operator moves the connector 31 relative to the counterpart connector 21 in the first direction X1, so that the connector housing 33 is first slightly fit onto the counterpart housing 23 as illustrated in FIG. 5. Thus, the engaged portion 25 of the counterpart housing 23 is inserted into the slit 35d between the pair of engaging portions 35b and is allowed to be engaged with the engaging portions 35b. The operator then holds the lever 34 to move the lever 34 in the first direction Xl. Thus, the lever 34 moves from the first position P1 to the second position P2. At this point, the arm 35 pivots to move the engaging portions 35b in engagement with the engaged portion 25 as the lever 34 moves. The engaging portions 35b at this point operate to draw the engaged portion 25 inward, allowing the connector housing 33 to move relative to the counterpart housing 23 into a state of fit to the counterpart housing 23. Thus, the terminals 32 are electrically connected to the counterpart terminals 22. The operator then operates the operation portion 36a of the lock member 36 to move the lock member 36 from the third position P3 to the fourth position P4. Thus, the contact portion 36b of the lock member 36 is allowed to make contact with the shaft portion 35e of the arm 35, so that a movement of the arm 35 is regulated and a movement of the lever 34 located at the second position P2 to the first position P1 is regulated. This suppresses disengagement of the connector housing 33 from the counterpart housing 23, the disengagement being caused by, for example, external forces such as vibrations.

The effects of the embodiment will be described below.

(1) When the lever 34 is moved from the first position P1 to the second position P2, the connector housing 33 is fit onto the counterpart housing 23. Thereafter, when the lock member 36 is located at the fourth position P4, the lock member 36 regulates a movement of the arm 35 so as to regulate a movement of the lever 34 located at the second position P2, thereby keeping the fit state. The lock member 36 regulates a movement of the arm 35 by making contact with the arm 35 that moves in a direction different from the moving direction of the lever 34 according to a movement of the lever 34. Hence, for example, as compared with a simple conventional configuration that keeps a state of fit to a protrusion extending in a direction crossing the first axis X, a fit state can be more firmly kept. In other words, the lock member 36 is configured to keep a fit state by regulating a movement of the arm 35 while making contact with the arm 35 that moves in a different direction from the first axis X, along which the counterpart housing 23 and the connector housing 33 are fit to each other, thereby firmly keeping the fit state.

(2) The arm 35 has the engaging portions 35b that can be engaged with the engaged portion 25 of the counterpart housing 23. The arm 35 then moves as the lever 34 moves from the first position P1 to the second position P2, and the engaging portions 35b in engagement with the engaged portion 25 of the counterpart housing 23 also move, so that the connector housing 33 can be brought close to a state of fit to the counterpart housing 23.

(3) In a state in which the lever 34 is located at the first position P1, a movement of the lock member 36 from the third position P3 to the fourth position P4 is regulated. Thus, a wrong operation of moving the lock member 36 from the third position P3 to the fourth position P4 with the lever 34 located at the first position P1 can be prevented. This can avoid interference with a movement of the lever 34 in the event of, for example, a wrong operation of the lock member 36, thereby avoiding problems, for example, interference with a fit of the connector housing 33 onto the counterpart housing 23.

(4) The lock member 36 does not overlap the moving path K1 of the shaft portion 35e from the fifth position P5 to the sixth position P6 in a state in which the lock member 36 is located at the third position P3, so that a movement of the arm 35 is not regulated and a movement of the lever 34 is not regulated either. Moreover, the lock member 36 overlaps the moving path K1 of the shaft portion 35e from the fifth position P5 to the sixth position P6 in a state in which the lock member 36 is located at the fourth position P4, so that a movement of the arm 35 is regulated. Thus, a movement of the lever 34 located at the second position P2 to the first position P1 is regulated, thereby keeping a fit state.

(5) The shaft portion 35e constitutes the coupling portion 35f that is drivingly coupled to the lever 34 so as to move the arm 35 in a direction different from the moving direction of the lever 34 according to a relative movement of the lever 34. Thus, the shape of the arm 35 is simplified as compared with the case where a configuration separate from the shaft portion 35e serves as the coupling portion 35f. In other words, the shaft portion 35e that can make contact with the lock member 36 also constitutes the coupling portion 35f drivingly coupled to the lever 34. Thus, the shape of the arm 35 can be simplified as compared with that in separate configurations.

(6) The lock member 36 and the shaft portion 35e have the lock-side first flat surface 36e and the shaft-side first flat surface 35g that can make surface contact with each other. Thus, the contact portion is unlikely to be broken as compared with, for example, that of a configuration having point contact or line contact. Hence, the lock member 36 and the shaft portion 35e can be brought into contact with each other at a stable position.

(7) The lock member 36 and the shaft portion 35e have the lock-side second flat surface 36f and the shaft-side second flat surface 35h that can make surface contact with each other. Thus, the contact portion is unlikely to be broken as compared with, for example, that of a configuration having point contact or line contact. Hence, the lock member 36 and the shaft portion 35e can be brought into contact with each other at a stable position.

The present embodiment can be implemented with the modifications below. The present embodiment and the following modification examples can be implemented in combination unless technical contradictions arise.

In the foregoing embodiment, the arm 35 has the engaging portions 35b that can be engaged with the engaged portion 25 of the counterpart housing 23. The configuration is not limited thereto, and the engaging portions 35b may be omitted. In other words, the connector housing 33 may be modified to another configuration if the configuration approaches a state of fit to the counterpart housing 23 as the lever 34 moves from the first position P1 to the second position P2. For example, the arm 35 may be configured to be drivingly coupled to still another member that is engaged with the counterpart housing 23 to operate in the same manner as in the foregoing embodiment.

In the foregoing embodiment, in a state in which the lever 34 is located at the first position P1, a movement of the lock member 36 from the third position P3 to the fourth position P4 is regulated. The configuration is not limited thereto, and the movement may be unregulated.

In the foregoing embodiment, the arm 35 has the shaft portion 35e that can make contact with the lock member 36. The configuration is not limited thereto. For example, the lock member 36 may be configured to regulate a movement of the arm 35 by making contact with a portion different from the shaft portion 35e of the arm 35.

In the foregoing embodiment, the shaft portion 35e that can make contact with the lock member 36 also constitutes the coupling portion 35f that is drivingly coupled to the lever 34. The configuration is not limited thereto. For example, the shaft portion 35e and the coupling portion 35f may be provided at different positions.

In the foregoing embodiment, the contact portion 36b has the lock-side first flat surface 36e along the first axis X. The configuration is not limited thereto, and the lock-side first flat surface 36e may be omitted. Moreover, the shaft portion 35e has the shaft-side first flat surface 35g that can make surface contact with the lock-side first flat surface 36e. The configuration is not limited thereto, and the shaft-side first flat surface 35g may be omitted. In other words, the lock member 36 and the shaft portion 35e may be configured to make, for example, point contact or line contact in a direction along the second axis Y.

In the foregoing embodiment, the contact portion 36b has the lock-side second flat surface 36f along the second axis Y. The configuration is not limited thereto, and the lock-side second flat surface 36f may be omitted. Moreover, the shaft portion 35e has the shaft-side second flat surface 35h that can make surface contact with the lock-side second flat surface 36f. The configuration is not limited thereto, and the shaft-side second flat surface 35h may be omitted. In other words, the lock member 36 and the shaft portion 35e may be configured to make, for example, point contact or line contact in a direction along the first axis X.

In the foregoing embodiment, the plurality of arms 35 may be provided for the single connector 31, which has not been particularly mentioned. For example, the arms 35 may be provided on the front and back sides of the connector 31 along the third axis Z or laterally provided along the second axis Y. As a matter of course, the portion provided with the arm 35 needs to have configurations for the arm 35, for example, the slit 33b and the rotating shaft 33c. Moreover, the counterpart housing 23 surely needs to be provided with the engaged portions 25 corresponding to the arms 35.

In the foregoing embodiment, the plurality of lock members 36 may be provided for the single connector 31, which has not been particularly mentioned. For example, the lock members 36 may be provided on the front and back sides of the connector 31 along the third axis Z or laterally provided along the second axis Y. As a matter of course, the portion provided with the lock member 36 needs to have configurations for the lock member 36, for example, the mounting portion 34d.

In the foregoing embodiment, the counterpart connector 21 includes the two counterpart terminals 22 and the connector 31 includes the two terminals 32. The number of counterpart terminals 22 and the number of terminals 32 may be changed to other numbers, e.g., one or three or more.

As illustrated in FIG. 6, like the terminals 32 are electrically connected to the counterpart terminals 22, a state in which the connector housing 33 is fit onto the counterpart housing 23 may be referred to as a normal fit state. As illustrated in FIG. 5, a state in which the connector housing 33 is fit onto the counterpart housing 23 at a position ahead of a position in the normal fit state in the first opposite direction X2 may be referred to as an initial fit state. The initial fit state is a state in which the connector housing 33 and the counterpart housing 23 are slightly fit to each other and may be a state in which the engaged portion 25 is placed between the distal end portions of the pair of engaging portions 35b into engagement with the engaging portions 35b.

As illustrated in FIG. 5, when the position of the lever 34 is held at the first position P1, the connector housing 33 is moved from the position of the initial fit state in the first direction X1 by the arm 35 coming into contact with the engaged portion 25. The movement of the connector housing 33, that is, the approach to the normal fit state may be regulated. In this way, the approach of the connector housing 33 from the initial fit state to the normal fit state is regulated when the lever 34 is held at the first position P1. This is because the rotation of the arm 35 in synchronization with sliding of the lever 34 is regulated by holding the position of the lever 34. The engaging portions 35b may include the slit 35d where the engaged portion 25 can be inserted. The slit 35d may be curved to cross the first axis X.

As illustrated in FIGS. 5 and 6, the lock member 36 may move between the third position P3 and the fourth position P4 by moving along the first axis X. As illustrated in FIG. 6, if the lever 34 is moved to the first position P1 in a state in which the lever 34 is located at the second position P2 and the lock member 36 is located at the fourth position P4, the shaft-side first flat surface 35g of the shaft portion 35e may press the contact portion 36b of the lock member 36 in the second opposite direction Y2, and the shaft-side second flat surface 35h may press the contact portion 36b in the first direction X1. In other words, if the lever 34 is being moved to the first position P1, the shaft portion 35e may press the lock member 36 in a direction crossing the first axis X (the moving direction of the lock member 36).

As illustrated in FIGS. 1 and 2, the lever 34 may be shaped like a cylinder surrounding the outer periphery of the connector housing 33. As illustrated in FIGS. 5 and 6, the lever 34 may be slidable with respect to the connector housing 33 along the first axis X. The lever 34 may be referred to as a slide lever.

The counterpart connector 21 may be referred to as a first connector, and the connector 31 may be referred to as a second connector. The counterpart terminal 22 may be referred to as a first terminal, and the terminal 32 may be referred to as a second terminal. The counterpart housing 23 may be referred to as a first connector housing, and the connector housing 33 may be referred to as a second connector housing.

The present disclosure includes the implementation examples below. The reference numerals of some of constituent elements in the exemplary embodiment are indicated in the implementation examples as a supplement to understanding, not as limitations. Some of matters described in the following implementation examples may be omitted, or some of matters described in the implementation examples may be selected or extracted in combination.

[Note 1] According to an aspect of the present disclosure, the connector housing (33) may be configured such that only one end of the connector housing (33) in the first direction (X1) can be fit onto the counterpart housing (23) in a state in which the lever (34) is located at the first position (P1), and
the connector housing (33) may be configured to approach a state of fit to the counterpart housing (23) as the lever (34) moves from the first position (P1) to the second position (P2) in a state in which only one end of the connector housing (33) in the first direction (X1) is fit onto the counterpart housing (23).

[Note 2] A connector (31) according to some aspects of the present disclosure may be a connector (31) that is moved in a first direction (X1) along a first axis (X) so as to be connected to a counterpart connector (21) including counterpart terminals (22) and a counterpart housing (23), the connector (31) including: terminals (32) connectable to the counterpart terminals (22); a connector housing (33) that accommodates the terminals (32), the connector housing (33) being allowed to be fit in a normal fit state in which the connector housing (33) is fit onto the counterpart housing (23) to electrically connect the terminals (32) to the counterpart terminals (22); a lever (34) that is mounted on the connector housing (33) and is slidable with respect to the connector housing (33) along the first axis (X) between a first position (P1) and a second position (P2) shifted from the first position (P1) in the first direction (X1); and an arm (35) that is mounted on the connector housing (33) and is coupled to the lever (34) so as to move in a direction different from the sliding direction of the lever (34) according to a slide of the lever (34); and a lock member (36) that is mounted on the lever (34) and is movable relative to the lever (34) in the range from a third position (P3) and a fourth position (P4), wherein the connector housing (33) may be configured to be fit in an initial fit state in which the connector housing (33) is located at a position shifted from a position in the normal fit state with respect to the counterpart housing (23) in a first opposite direction (X2) opposite to the first direction (X1), in a state in which the lever (34) is located at the first position (P1), the connector housing (33) may be configured to be placed in the normal fit state by moving the lever (34) from the first position (P1) to the second position (P2) in the initial fit state, and the lock member (36) may regulate a movement of the lever (34) at the second position (P2) by regulating a movement of the arm (35) such that the lock member (36) is not allowed to make contact with the arm (35) in a state in which the lock member (36) is located at the third position (P3), and is allowed to make contact with the arm (35) in a state in which the lock member (36) is located at the fourth position (P4).

[Note 3] According to an aspect of the present disclosure, the connector housing (33) may be configured to regulate a shift from the initial fit state to the normal fit state when the lever (34) is held at the first position (P1).

[Note 4] According to an aspect of the present disclosure, the connector housing (33) may be configured such that when the lever (34) is held at the first position (P1), the arm (35) comes into contact with the engaged portion (25) of the counterpart housing (23) so as to regulate a shift from the initial fit state to the normal fit state.

[Note 5] According to an aspect of the present disclosure, the arm (35) may have engaging portions (35b) that can be engaged with the engaged portion (25), the engaging portions (35b) may include a slit (35d) where the engaged portion (25) can be inserted, and the slit (35d) may be curved to cross the first axis (X).

### LIST OF REFERENCE NUMERALS

11 connector assembly
21 counterpart connector
22 counterpart terminal
23 counterpart housing
23a wall portion
24 protruding extension
25 engaged portion
31 connector
32 terminal
33 connector housing
33a wall portion
33b slit
33c rotating shaft
33d wall portion
33e rail portion
34 lever
34a concave portion
34b wall portion
34c coupled portion
34d Mounting portion
34e Side wall portion
34f Lid portion
34g First holding hole
34h Second holding hole
35 arm
35a central hole
35b engaging portion
35c extended portion
35d slit
35e Shaft portion
35f Coupling portion
35g Shaft-side first flat surface
35h Shaft-side second flat surface
36 Lock member
36a Operation portion
36b Contact portion
36c Position-keeping piece
36d Position-keeping protrusion
36e Lock-side first flat surface
36f Lock-side second flat surface
K1 Moving path
P1 first position
P2 second position
P3 third position
P4 fourth position
P5 fifth position
P6 sixth position
WH wire harness
X first axis
X1 first direction
X2 first opposite direction
Y second axis
Y1 second direction
Y2 second opposite direction
Z third axis

1. A connector connectable to a counterpart connector by a relative movement in a first direction along a first axis, the counterpart connector including a counterpart terminal and a counterpart housing, the connector comprising:
a terminal connectable to the counterpart terminal;
a connector housing that accommodates the terminal and is allowed to be fit onto the counterpart housing;
a lever that is mounted on the connector housing and is movable relative to the connector housing along the first axis in a range from a first position to a second position ahead of the first position in the first direction;
an arm that is mounted on the connector housing, is drivingly coupled to the lever, and moves in a direction different from a moving direction of the lever according to a relative movement of the lever; and
a lock member that is mounted on the lever and is movable relative to the lever in a range from a third position to a fourth position, wherein
the connector housing is configured to approach a state of fit to the counterpart housing as the lever moves from the first position to the second position, and
the lock member regulates a movement of the lever located at the second position by regulating a movement of the arm such that the lock member is not allowed to make contact with the arm in a state in which the lock member is located at the third position, and is allowed to make contact with the arm in a state in which the lock member is located at the fourth position.

2. The connector according to claim 1, wherein the arm has an engaging portion that is allowed to be engaged with an engaged portion of the counterpart housing, and
the connector housing is configured to move relative to the counterpart housing and approach a state of fit to the counterpart housing as the engaging portion in engagement with the engaged portion moves according to a movement of the lever from the first position to the second position.

3. The connector according to claim 1, wherein a movement of the lock member from the third position to the fourth position is regulated in a state in which the lever is located at the first position.

4. The connector according to claim 1, wherein the arm has a shaft portion that is allowed to make contact with the lock member,
the shaft portion moves from the fifth position to the sixth position as the lever moves from the first position to the second position, and
the lock member does not overlap a moving path of the shaft portion from the fifth position to the sixth position in a state in which the lock member is located at the third position, and the lock member overlaps the moving path of the shaft portion from the fifth position to the sixth position in a state in which the lock member is located at the fourth position.

5. The connector according to claim 4, wherein the shaft portion constitutes a coupling portion that is drivingly coupled to the lever so as to move the arm in a direction different from the moving direction of the lever according to a relative movement of the lever.

6. The connector according to claim 4, wherein the lock member has a lock-side first flat surface along an axis, along which the lock member is movable with respect to the lever, and
the shaft portion has a shaft-side first flat surface that is allowed to make surface contact with the lock-side first flat surface.

7. The connector according to claim 4, wherein the lock member has a lock-side second flat surface along an axis orthogonal to an axis along which the lock member is movable with respect to the lever, and
the shaft portion has a shaft-side second flat surface that is allowed to make surface contact with the lock-side second flat surface.

8. A connector assembly comprising:
the connector according to claim 1, and
the counterpart connector.
